(19) United States
(12) Patent Application Publication
(10) Pub. No.: US 2025/0216825 A1
(43) Pub. Date: Jul. 3, 2025

(54) CONVERTIBLE CHECK-OUT STATION

(71) Applicant: Lozier Corporation, Omaha, NE (US)

(72) Inventors: Ben O’Brien, Omaha, NE (US); Jeffrey Swamson, Omaha, NE (US); Tyler Holm, Omaha, NE (US); Scott Muller, Omaha, NE (US); Christopher Hellstrom, Omaha, NE (US); Matt Ramon, Frisco, TX (US); Hoang Nguyen, Frisco, TX (US); Kevin Huljich, Eagan, MN (US); Jeff Klemm, Eagan, MN (US); Dan Breunig, Eagan, MN (US); Ryan Murray, Eagan, MN (US); Gregory Judkins, Eagan, MN (US)

(21) Appl. No.: 19/004,753

(22) Filed: Dec. 30, 2024

Related U.S. Application Data
(60) Provisional application No. 63/616,274, filed on Dec. 29, 2023.

(51) Int. Cl. G05B 15/02; G06Q 10/0631

(52) U.S. Cl. CPC G05B 15/02; G06Q 10/063118

(57) ABSTRACT

The claims pertain to a convertible checkout station that can be converted between self-service and staffed stations. This is achieved through a rotatable section that includes at least a scanner and has rotation components that remain within a volume of the housing of the station when converting. The convertible checkout station can be manually or electronically rotated. For the electronic or automated rotation, the convertible checkout station includes a motor that rotates the rotatable section in response to a mode signal. The mode signal can be initiated through a manual control interface or received from a station controller. The station controller can generate the mode signal based on remote mode instructions. The checkout station may also include a station controller that directs the operation of the motor.

### CROSS-REFERENCE TO RELATED APPLICATIONS

This application claims the benefit of U.S. Provisional Application Ser. No. 63/616,274 filed by Ben O'Brien et al. on Dec. 29, 2023, entitled “MOTORIZED CONVERTIBLE CHECK-OUT STATION”, which is commonly assigned with this application and incorporated herein by reference in its entirety.

### TECHNICAL FIELD

This disclosure pertains to the field of retail technology, specifically focusing on checkout stations that are convertible between self-checkout and traditional staffed checkout stations.

### BACKGROUND

In the retail industry, checkout stations play a crucial role in the customer's shopping experience. Checkout stations are either staffed by cashiers or are self-checkout stations, with each type of station having its own advantages and disadvantages. For instance, staffed checkout stations can process transactions faster as cashiers are experienced in handling the scanning and bagging process. These stations, however, require more labor and can lead to longer queues during peak hours. On the other hand, self-checkout stations can reduce labor costs and allow customers to checkout at their own pace. Nevertheless, customers may not be as efficient as cashiers; especially for customers with large amounts of items. Furthermore, the static nature of the stations does not allow for flexibility based on changing store conditions such as customer traffic or available staff. Additionally, safety can be a concern in the design and operation of these stations, especially when they involve moving parts.

### SUMMARY

In one aspect, the disclosure provides a convertible checkout station capable of being automatically converted between self-service and staffed stations. In one example, the convertible checkout station includes: (1) a rotatable section including a scanner and (2) a motor that rotates the rotatable section between a self-service station and a staffed station.

In another aspect, the disclosure provides another convertible checkout station. In one example, this convertible checkout station includes: (1) a housing, and (2) a rotatable section including a scanner, wherein the rotatable section includes a platter that remains within a volume defined by the housing when converting the checkout station between a self-service checkout station and a staffed checkout station.

In yet another aspect, the disclosure provides a method of automatically converting an automated convertible checkout system (ACCS). In one example, the method includes: (1) receiving a mode instruction, (2) activating a motor in response to the mode instruction, and (3) rotating a rotatable section of the ACCS using the motor after the activating.

In still yet another aspect, the disclosure provides a checkout management system. In one example, the checkout management system includes: (1) one or more multiple convertible checkout stations that are each capable of being converted between self-service and staffed stations and (2) a checkout management controller that generates and sends a remote mode instruction to one or more of the multiple convertible checkout stations, wherein the remote mode instruction indicates conversion between a self-service mode and a staffed mode.

### BRIEF DESCRIPTION

Reference is now made to the following descriptions taken in conjunction with the accompanying drawings, in which:

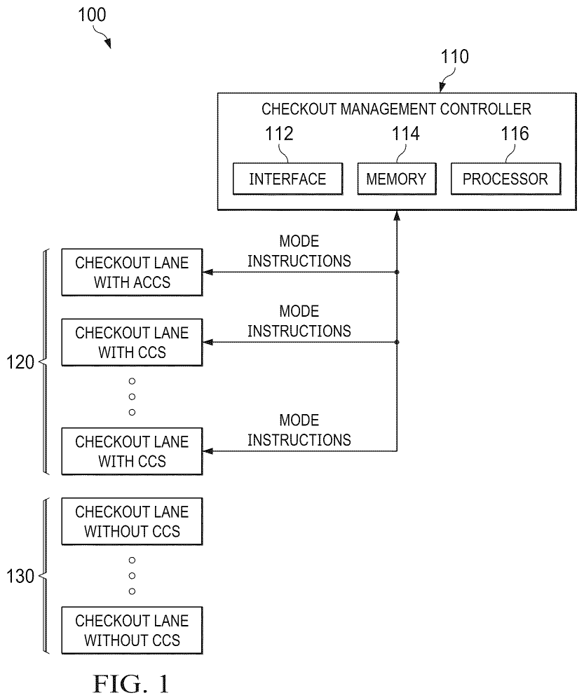

FIG. 1 illustrates a block diagram of an example of a checkout management system having at least one CCS constructed according to the principles of the disclosure;

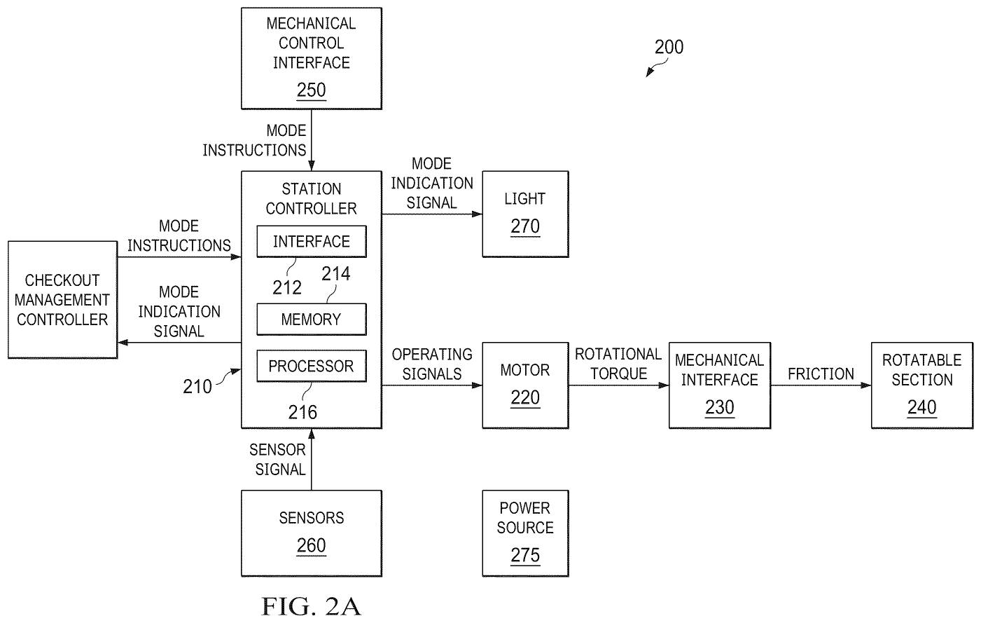

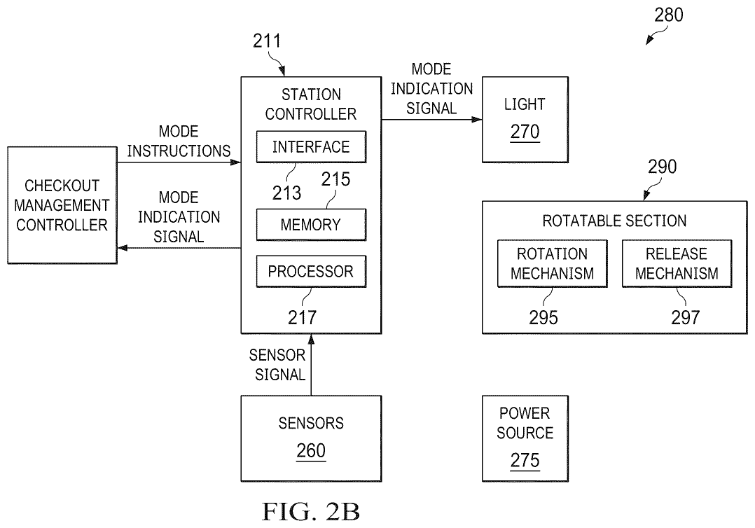

FIG. 2A illustrates a block diagram of an example of an ACCS constructed according to the principles of the disclosure;

FIG. 2B illustrates a block diagram of an example of a CCS constructed according to the principles of the disclosure;

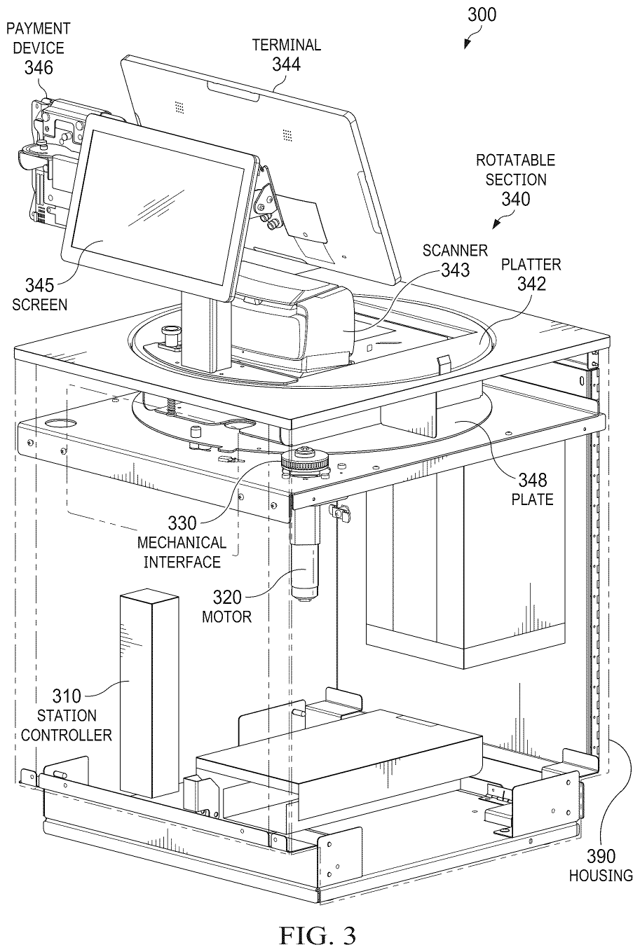

FIG. 3 illustrates a cut-away view of an example of an ACCS constructed according to the principles of the disclosure;

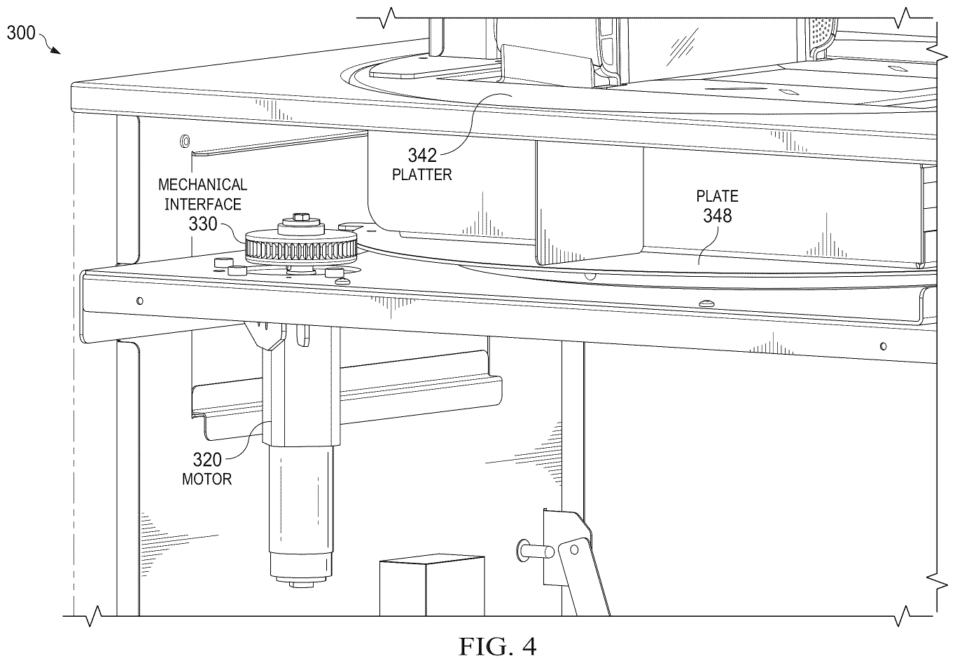

FIG. 4 illustrates an enlarged view of the ACCS of FIG. 3 showing the motor, the mechanical interface, and the platter and plate of the rotatable section;

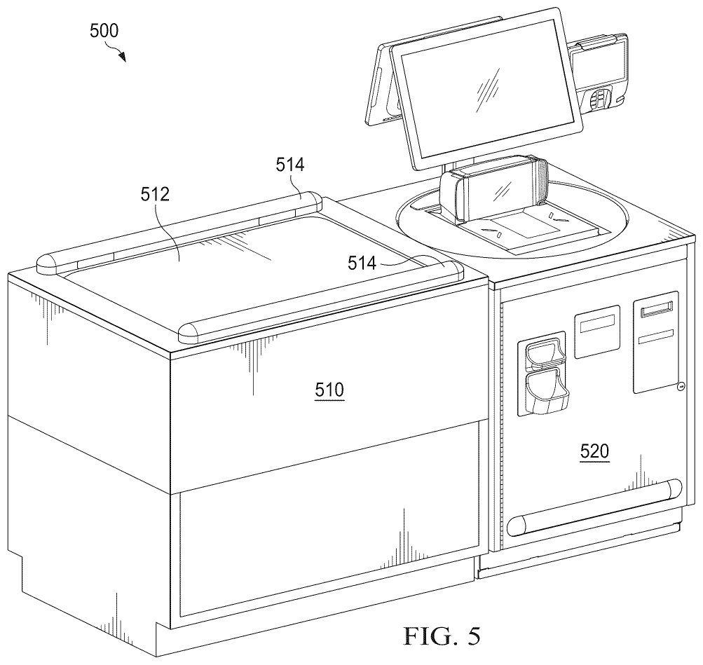

FIG. 5 illustrates an example of a checkout lane that includes a product staging area, and a CCS constructed according to the principles of the disclosure;

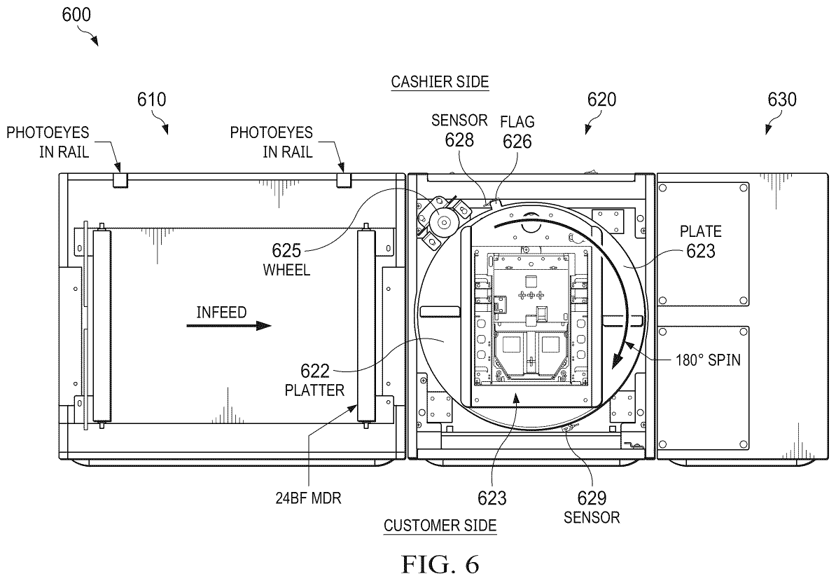

FIG. 6 illustrates a top view of an example of a checkout lane having an ACCS constructed according to the principles of the disclosure;

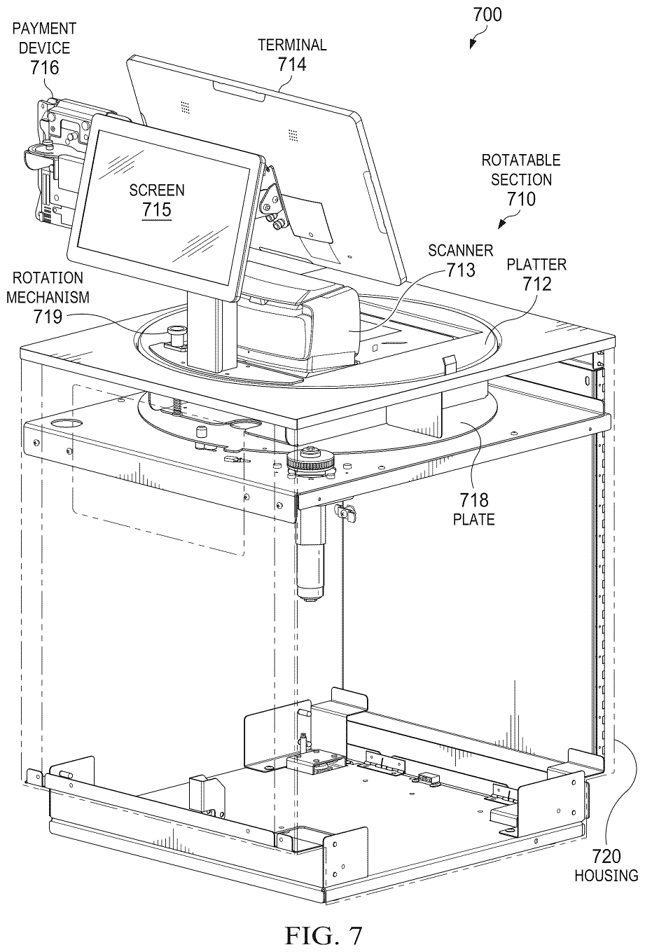

FIG. 7 illustrates a cut-away view of an example of a CCS constructed according to the principles of the disclosure; and

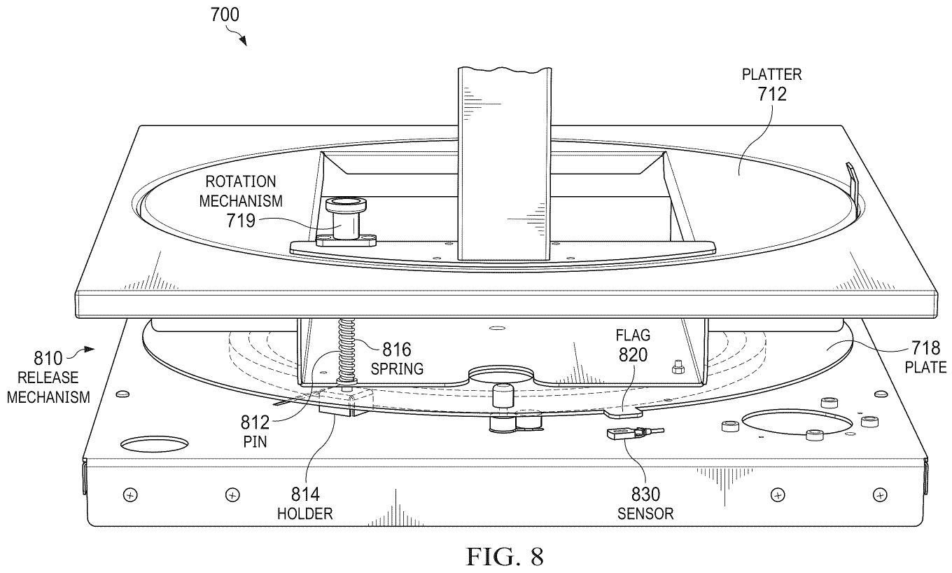

FIG. 8 illustrates an enlarged view of the CCS of FIG. 7 showing the platter and plate of the rotatable section with the rotation mechanism.

### DETAILED DESCRIPTION

The static nature of checkout stations that are dedicated to either self-checkout or staff-checkout does not allow for flexibility based on changing store conditions, such as customer traffic or available staff. A checkout station that can be switched between self and staff checkout can help with flexibility but can create safety problems due to the design and operation when switching. For example, moving parts can cause harm to cashiers or other employees during the switching process. Thus, a checkout station that can be easily and safely converted between self and staff checkouts would be beneficial.

The disclosure provides a convertible checkout station that can be safely converted between self-checkout and staff-checkout stations. The disclosed convertible checkout stations (CCSs) are designed for retail environments and allow switching between self-service and staff-checkout stations, which provides flexibility for retail stores, such as grocery stores, based on the store's needs and customer traffic. The CCS includes a housing and a rotatable section that allows switching between the two different types of checkout stations. Advantageously, the rotatable section rotates within the housing such that staff and customers are protected from moving parts. The rotatable section can be rotated manually or by a motor. Accordingly, an automated CCS (ACCS) as disclosed herein also includes a motor that is located within the housing. The housing can be constructed of a metal, such as one typically used for metal cabinets in the industry.

The CCS provides a safe solution for streamlining the checkout process in retail environments. An example of a retail environment or retail store is a grocery store, which may be used herein as an example for retail stores. The ability to convert between self-service and staffed modes offers advantages in terms of efficiency and flexibility. For example, one or more CCS can be part of a checkout management system. The ACCS further leverages motorized rotation and flexible control mechanisms that contribute to efficient and flexible checkout systems.

FIG. 1 illustrates a block diagram of an example of a checkout management system 100 having at least one CCS constructed according to the principles of the disclosure. The checkout management system 100 includes a checkout management controller 110 and one or more checkout lanes. A checkout lane as used herein includes a checkout station, which can be an CCS, and can also include a product staging area and bagging area. The staging area can include a conveyor, such as illustrated in FIG. 5. Instead of an CCS, the checkout station can be non-convertible or fixed. In FIG. 1, one or more checkout lanes that include a CCS are denoted by element number 120 and one or more checkout lanes that do not include a CCS are represented by element number 130. Instead of being separated as shown in FIG. 1, the checkout lanes having a CCS and not having a CCS can be interleaved. In some examples, all of the checkout lanes of the checkout management system 100 may have a CCS.

One or more of the CCSs can be an ACCS. As an example, checkout lane 122 is specifically denoted as a checkout lane with an ACCS. More than one of the checkout lanes 120 can include ACCS. For example, all of the checkout lanes 120 can include an ACCS. FIGS. 2A and 2B illustrate examples of an ACCS and a CCS that can be used in the checkout lanes 120.

The checkout management controller 110 is configured to manage the configuration of checkout lanes for a retail store. For example, the checkout management controller 110 can determine the number of checkout lanes that need to be opened and the number of opened checkout lanes that should be staffed or are available for self-checkout. The checkout management controller 110 can optimize the configuration of checkout lanes based on various factors, such as, a number of cashiers available, time of day, historical data, total number of checkout lanes, number of customers presently within the retail store, or a combination thereof. The checkout management controller 110 can send mode instructions (i.e., mode instruction signals) to the checkout lanes 120 indicating the type of checkout lane that is needed. Checkout lane 122 can be remotely controlled or configured. As such, the mode instructions can automatically initiate converting the ACCS. For the checkout lanes of 120 having a CCS, the mode instructions can indicate to a cashier to manually change to a self-checkout station or initiate an audio and/or visual signal indicating a self-checkout station is being switched to a staff-checkout station. The remote mode instructions can be sent using a wireless and/or wired connections.

The checkout management controller 110 includes one or more communication interfaces represented by interface 112, one or more memories or data storage represented by memory 114, and one or more processors represented by processor 116. The interface 112 is configured to send and receive data, such as the mode instructions. The memory 114 is configured to store data including operating instructions that direct the operation of the processor 116. The operating instructions correspond to one or more algorithms directed to managing and/or optimizing the configuration of checkout lanes for a retail store such as disclosed herein.

FIG. 2A illustrates a block diagram of an example of an ACCS 200 constructed according to the principles of the disclosure. The ACCS 200 includes a station controller 210, a motor 220, a mechanical interface 230, a rotatable section 240, a manual control interface 250, one or more sensors represented by sensors 260, a lane indication light 270, and a power source 275. The ACCS 200 also includes a power source 205 the provides the needed power for the ACCS 200, such as for the station controller 210, motor 220, sensors 260, and light 270. Though all of the components of ACCS 200 are not shown, FIG. 3 illustrates a cut-away view that provides an example configuration of ACCS 200.

The station controller 210 is configured to direct operation of the motor 220 by sending operating signals to initiate and stop rotation of the rotatable section 240. The station controller 210 can generate an operating signal to initiate rotation based on a mode instruction. The mode instruction can be a remote mode instruction received from a controller or system that is external to the ACCS 200, such as a checkout management controller or system as shown in FIG. 1. The mode instruction can also be a local remote mode instruction received from the manual control interface 250. The station controller 210 can generate an operating signal to stop rotation based on a sensor signal received from the sensors 260. One of the sensors 260 can indicate when rotation is complete for a staff-checkout station and another one of the sensors 260 can indicate when rotation is complete for a self-checkout station. Essentially, the sensors 260 can indicate when 180 degrees of rotation has been completed. The sensors 260 can be, for example, an optical sensor or an electrical switch. Other types of sensors can also be used to indicate rotation is complete. If a sensor signal is not received a designated amount of time after an initiating operating signal is sent, then the station controller 210 can generate an alarm or send a signal, text, etc., indicate a potential problem. The mode instructions, whether remote or local, and/or the sensor signals can be received via wireless or wired connections.

Similar to the checkout management controller 110, the station controller 210 also includes one or more communication interfaces represented by interface 212, one or more memories or data storage represented by memory 214, and one or more processors represented by processor 216. The interface 212 is configured to send and receive data, such as receive the mode instructions and send the operating signals. The memory 214 is configured to store data including operating instructions that direct the operation of the processor 216. The memory 214 (and the memory 114) can be non-transitory memories. The operating instructions correspond to one or more algorithms directed to generating operating signals for the motor 220 based on mode instructions received and other functions disclosed herein. The mode instructions can be received remotely and/or locally. In some examples, an ACCS may only rely on a manual control interface and not be configured to receive remote mode instructions. In other examples, an ACCS may not include a manual control interface and only use remote mode instructions.

The other functions can include, for example, sending a completion signal, such as to a checkout management controller, indicating rotation is complete. Other generated signals can include a mode indication signal (staff or self-checkout), which can also be sent to the checkout management controller and/or a lane indication light 270 that provides a visual indication of the type of checkout station, and an error signal indicating if there is a problem with the ACCS 200, such as an incomplete rotation. The light 270 can use different colors and/or flashing sequences to indicate mode, error, or time for converting.

The motor 220 is the driving force that powers rotation of the rotatable section 240. The motor 220 is activated in response to an initiating operating signal and is deactivated in response to a stop operating signal. The motor 220 can be an electric motor or another type of powered motor. Advantageously all of the moving parts of the motor are located within the housing of the ACCS 200 to protect customers and staff. The motor 220 can rotate the rotatable section 240 via a mechanical interface 230. The motor 220 and the mechanical interface 230 are rotation components that are advantageously located within the housing of the ACCS 200.

The mechanical interface 230 is used to transfer force and is configured to transfer the rotational torque from the motor 230 to the rotatable section 240 for rotation. As noted in FIG. 2A, friction can be used for the transfer. For example, the mechanical interface 230 can be a wheel that contacts a portion of the rotatable section 240 and when the wheel is rotated by the motor 220, the contacted portion is also rotated via friction between the wheel and contacted portion. The contacted portion can be a plate. The wheel can be constructed of plastic and the plate can be constructed of a metal with a rubber edging that interacts with the wheel. FIGS. 6 and 7 illustrate examples of a wheel and plate that can be used. Using friction to transfer the rotational force of the motor 220 advantageously provides another safety feature by allowing slipping between the plate and the wheel due to, for example, a person (such as a finger or hand) in the way of the rotation.

The rotatable section 240 rotates in response to operation of the motor 220. The rotatable section 240 includes at least a scanner and can also include a terminal and a payment device. The scanner is used to scan the products being purchased by the customers by reading, for example, the barcodes of the products. The terminal provides a user interface for customers or staff to interact with the ACCS 200. For example, the terminal can include a screen that visually indicates items that have been scanned, provide instructions for checking out, etc. The terminal can also include a speaker and/or a microphone for verbal communication. The payment device is configured to receive payment for the products being purchased, such as via cash, credit card, or both. When present, the scanner, terminal, and payment device can be located on a platter of the rotatable section 240 and extend above the housing of the ACCS 200. In some examples, the terminal and payment device may not be located in the rotatable section 240 but can be fixed to the top of the housing. The scanner, terminal, and payment devices can be typical components used in the industry in checkout lanes.

The manual control interface 250 is configured to generate a local mode instruction when activated. The manual control interface 250 can be a push button switch, a toggle switch, or a button on a touchscreen, such as a button on the terminal. As such, the mode instruction signal can be initiated by flipping a switch or pressing a screen, providing a way for users to control the operation of the checkout station.

FIG. 2B illustrates a block diagram of an example of a CCS 280 constructed according to the principles of the disclosure. The CCS 280 may include some of the same components as the ACCS 200 of FIG. 2A and the same element numbers are used for these components. As such, the CCS 280 includes sensors 260, lane indication light 270, and power source 275. Unlike ACCS 200, however, the CCS 280 does not include the motor 220 or mechanical interface 230. Instead, the CCS 280 includes a rotatable section 290 that is manually rotated via a rotation mechanism 295. Though all of the components of CCS 280 are not shown, FIG. 7 illustrates a cut-away view that provides an example configuration of CCS 280.

Additionally, while the CCS 280 can include a station controller 211, the station controller 211 is not configured to generate operating signals to initiate the motor 220 based on mode instructions. The station controller 211, however, can still perform other operations of the station controller 210, such as communicate with a checkout management controller and generate signals based on inputs received from the sensors 260. As with the station controller 210, the station controller 211 includes an interface 213, a memory 215, and a processor 217 that cooperate to generate the various signals and communicate with the checkout management controller. Accordingly, the interface 213 is configured to send and receive data and the memory 215 is configured to store data including operating instructions that direct the operations of the processor 216. The memory 215 can be a non-transitory memory. The operating instructions correspond to one or more algorithms directed to generating signals based on one or more of mode instructions, sensor signals, or the other functions disclosed herein. As noted above with respect to the ACCS 200, the other functions can include, for example, sending a completion signal, a mode indication signal, and or an error signal.

The rotatable section 290 rotates in response to movement initiated through the rotation mechanism 295. The rotation mechanism 295 can be a knob, a handle, an indentation, a textured area, etc, that enables rotation of the rotatable section 290 when a rotational force is applied thereto. The CCS 280 can also include a release mechanism 297 that prevents rotation of the rotatable section 290 when activated and allows rotation when released. The release mechanism 297, or at least a portion thereof, can be located on the rotatable section 290 as shown in FIG. 2B.

As with rotatable section 240, rotatable section 290 includes at least a scanner and can also include a terminal and a payment device. In some examples, the terminal and payment device may not be located in the rotatable section 290 but can be fixed to the top of the housing.

FIG. 3 illustrates a cut-away view of an example of an ACCS 300 constructed according to the principles of the disclosure. The ACCS 300 includes a station controller 310, a motor 320, a mechanical interface 330, a rotatable section 340, and a housing 390. The ACCS 300 can include other components that are not illustrated, such as a manual control interface, one or more sensors, a lane indication light, and a power source.

The rotatable section 340 includes a platter 342 with components located thereon and a plate 348. Located on the platter 342 is a scanner 343, a terminal 344, a visual interface or screen 345, and a payment device 346. As noted above, the scanner 345 is used to scan the products being purchased by the customers and the terminal 344 provides a user interface for customers or staff to interact with the ACCS 300. The screen 345 can provide an additional visual interface for customers when the ACCS 300 is in staff-mode. The payment device 346 is configured to receive payment for the products being purchased, such as via cash, credit card, or both. As shown, the scanner 343, terminal 344, screen 345, and payment device 346 are located on a platter 342 and extend above the housing 390. In some examples, one or more of the terminals 344, screen 345, and payment device 346 may not be located on the platter 342 but can be fixed to the top of the housing 390. The scanner 343, terminal 344, screen 345, and payment device 346 can be typical components used in the industry in checkout lanes.

FIG. 4 illustrates an enlarged view of the ACCS 300 showing the motor 320, the mechanical interface 330 and the platter 342 and plate 348 of the rotatable section 340. The mechanical interface 330 is a wheel with multiple ridges wherein the plate 348 fits within the ridges of the wheel. The motor 320 turns the mechanical interface 330, which is the wheel. As the wheel rotates, the plate 348 is turned due to friction between the plate 348 and the ridges of the wheel. As the plate 348 is rotated via the motor 320 and wheel 330, the platter 342 is also rotated. The plate 348, the mechanical interface 330, and the motor 320 are rotation components that are location within the housing 390 and remain within a volume of the housing 390 during the conversion process.

FIG. 5 illustrates an example of a checkout lane 500 that includes a product staging area 510 and an CCS 520, such as ACCS 200 or 300, or CCS 280 or 700. The product staging area 510 includes a conveyor 512 and conveyor lights 514. The conveyor lights 514 enhance communication during the checkout process by providing additional visual signals. The conveyor lights 514 change color to match a lane indication light (not visible) extending above the checkout lane 500. The conveyor lights 514 advantageously provide an additional visual signal to users at a visual level that differs from a visual level of the lane indication light. A controller, such as checkout management controller 110 or station controller 210, can direct operation of the conveyor lights 514 and the lane indication light. A lane indication light or sign is positioned above the checkout lane 500, such as by a pole or hanging from the ceiling.

FIG. 6 illustrates a top view of an example of a checkout lane 600 having an ACCS 620 constructed according to the principles of the disclosure. The ACCS 620 can be, for example, ACCS 200 or 300. The checkout lane 600 includes a product staging area 610, the ACCS 620, and a bagging area 630. The product staging area 610 includes a conveyor and photo eyes that indicate when product is on the conveyor. Instead of a conveyor, the product staging area can include a static counter where product is unloaded but not moved forward.

The ACCS 620 includes a rotational section having a platter 622 and a plate 623. Located on top of the platter is a scanner, a terminal, and a payment device, which are collectively denoted by element number 623. The ACCS 620 also includes a mechanical interface that is a wheel 625, which interacts with the plate 623 for rotation when the wheel 625 is rotated by a motor (not visible). The wheel 625 can have multiple ridges that interact with the plate 623 to cause rotation. The wheel 625 can be a three inch wheel and the plate 623 can have a diameter of twenty seven inches. Also illustrated is a flag 626 that is connected to the plate 623 and interacts with sensors 628 and 629 to indicate when rotation is complete. The sensors 628 and 629 can be switches that are operated by the flag 626 when the rotational section is rotated. As indicated in FIG. 6, the rotational section is rotated 180 degrees to convert between self and staff checkout stations. The wheel 625, plate 623, sensors 628 and 629, flag 626, and motor are rotation components that remain within the housing of the ACCS 620 during the conversion process.

In one example, a method of automatically converting the ACCS 620 includes receiving a mode instruction, activating the motor in response to the mode instruction to rotate the wheel 625, which causes rotation of the plate 623 and the rest of the rotatable section of the ACCS 620. A sensor signal from one or more of sensors 628, 629, can be received indicating rotating of the rotatable section is complete. The mode instruction can be locally or remotely received via either a wireless or wired connection. Operating signals can be generated to initiate the rotation and end the rotation based on the mode instruction (i.e., mode instruction signal) and the sensor signals, respectively.

FIG. 7 illustrates a cut-away view of an example of an CCS 700 constructed according to the principles of the disclosure. The CCS 700 includes a rotatable section 710 and a housing 720. The ACCS 700 can include other components that are not illustrated, such as a station controller, one or more sensors, a lane indication light, and a power source.

The rotatable section 710 includes a platter 712 with components located thereon and a plate 718. Located on the platter 712 is a scanner 713, a terminal 714, a visual interface or screen 715, and a payment device 716, which can all perform the same functions as indicated above regarding FIG. 3. One or more of the terminals 174, screen 175, and payment device 176 may not be located on the platter 172 but can be fixed to the top of the housing 720.

Located on the platter 712 is a rotation mechanism 719 that is used to manually rotate the rotatable section 710. In FIG. 7, the rotation mechanism 719 is a knob. As noted above, the rotation mechanism can be another component such as a handle.

FIG. 8 illustrates an enlarged view of the CCS 700 showing the platter 712 and plate 718 of the rotatable section 710 with the rotation mechanism 719. Also visible in FIG. 8 is a release mechanism 810 that includes a pin 812 and a holder 814. The release mechanism 810 operates with the rotation mechanism 719. A cashier (or another employee) can lift the rotational mechanism 719, which removes the pin 810 from the holder 814. With the pin 812 released from the holder, the cashier can then apply a rotational force on the rotational mechanism 719 to rotate the platter 712 and plate 718. Once rotation is complete, the cashier can release the rotation mechanism 719 such that the pin 812 is placed within another holder (not visible) located 180 degrees away from holder 814. A spring 816 located around the pin can allow movement vertical movement of the pin 812 and provide force to keep the pin 812 in the appropriate holder when the rotation mechanism 719 is released. A flag 820 and a sensor 830 are also shown that can be used to indicate when rotation is complete and the type of checkout mode. The flag 820 can cooperate with another sensor that is not visible in FIG. 8 to provide the mode and completion indication. Advantageously, rotation components of the rotatable section 710 that can cause pinch points remain within the housing 720 during switching between the different checkout modes.

The disclosure provides a CCS that can be safely switched between different self and staff checkout stations. The CCS, whether automated or manual, does not have a section that lifts up, down, or out when converting. Thus, there are no exposed pinch points, and all mechanisms for turning the platter are located within the housing, away from a user's hands.

The disclosed ACCS can switch electronically, using an internal motor and control mechanism. The internal motor turns a circular plate, which allows a top platter to spin. Installed on the top platter are monitors, a payment device, and a scanner bed. The motor allows the top platter to spin back and forth 180 degrees and can include mechanical and motorized stops at each extreme of the semi-circle. The motor can be controlled by a logic card, which has programmable inputs and outputs and allows a user to control orientation by many means: physical switches, sensors, pre-programmed logic, user interface software, etc.

A portion of the above-described apparatus, systems or methods may be embodied in or performed by various analog or digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate arrays (FPGA), or another type of computer processing device (CPD). The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein. A processor could be a CPU or a GPU.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured or configured to means, for example, designed, constructed, or programmed, with the necessary logic and/or features for performing a task or tasks. A configured device, therefore, is capable of performing the task or tasks. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, because the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Several aspects disclosed herein are represented by the below claims. Each one of the aspects can include one or more of the dependent claims in combination.

What is claimed is:

1. A convertible checkout station capable of being automatically converted between self-service and staffed stations, comprising:
a rotatable section including a scanner; and
a motor that rotates the rotatable section between a self-service station and a staffed station.

2. The convertible checkout station of claim 1, further comprising a station controller that directs operation of the motor by sending operating signals to initiate and stop rotation of the rotatable section.

3. The convertible checkout station of claim 2, wherein the station controller includes a processor, a memory, and an interface, wherein the interface receives mode instructions, and the processor generates the operating signals based on the mode instructions.

4. The convertible checkout station of claim 3, further comprising a manual control interface configured to generate the mode instructions when activated.

5. The convertible checkout station of claim 4, wherein the mode instructions are local signals generated by the manual control interface or remote signals received from a source external to the convertible checkout station, wherein the interface is configured to receive the local signals, the remote signals, and both the local and remote signals.

6. The convertible checkout station of claim 5, wherein the external source is a checkout management controller.

7. The convertible checkout station of claim 2, further comprising one or more sensors configured to generate sensor signal indicating when rotation of the rotatable section is complete.

8. The convertible checkout station of claim 7, wherein the interface is configured to receive the sensor signal, and the processor is configured to generate an operating signal for the motor to stop the rotation.

9. The convertible checkout station of claim 8, wherein the interface is configured to receive the mode instructions and the sensor signal from either a wireless or a wired connection.

10. The convertible checkout station of claim 8, further comprising a mechanical interface, wherein the motor rotates the rotatable section using the mechanical.

11. The convertible checkout station of claim 10, wherein the rotatable section includes a platter that interacts with the mechanical interface for the rotation.

12. The convertible checkout station of claim 10, further comprising a housing that includes the manual control interface, the station controller, the motor, the mechanical interface, the at least one sensor, and the rotatable section, wherein the rotatable section wholly rotates within a volume defined by the housing.

13. The convertible checkout station of claim 12, wherein the rotatable section further includes a terminal, and the terminal and scanner are located on the platter and extend above the housing.

14. The convertible checkout station of claim 1, wherein the motor is an electric motor.

15. A convertible checkout station, comprising:
a housing; and
a rotatable section including a scanner, wherein the rotatable section includes a platter that remains within a volume defined by the housing when converting the checkout station between a self-service checkout station and a staffed checkout station.

16. The convertible checkout station as recited in claim 15, wherein the rotatable section further includes a rotation mechanism and a plate.

17. A method of automatically converting an automated convertible checkout system (ACCS), comprising:
receiving a mode instruction;
activating a motor in response to the mode instruction; and
rotating a rotatable section of the ACCS using the motor after the activating.

18. The method of claim 17, wherein the mode instruction is received from a manual control interface.

19. The method of claim 17, wherein the motor is activated by a station controller that receives the mode instruction.

20. The method of claim 17, wherein the rotating ends in response to a sensor signal.

21. The method of claim 20, wherein the rotatable section is rotated 180 degrees, and the sensor signal indicates a rotation of 180 degrees.

22. The method of claim 17, wherein the rotating is within a volume corresponding to a housing of the ACCS.

23. The method of claim 17, wherein the mode instruction is received from a checkout management system.

24. The method of claim 22, wherein the checkout management system generates the mode instruction based on factors that include one or more of a number of cashiers present, time of day, historical data, or a number of customers.

25. The method of claim 22, wherein the checkout management system automatically generates the mode instruction.

26. The method of claim 22, wherein the checkout management system manages more than one ACCS.

27. A checkout management system, comprising:
one or more multiple convertible checkout stations that are each capable of being automatically converted between self-service and staffed stations; and
a checkout management controller that generates and sends a remote mode instruction to one or more of the multiple convertible checkout stations, wherein the remote mode instruction indicates conversion between a self-service mode and a staffed mode.

28. The checkout management system of claim 26, wherein at least one of the one or more convertible checkout stations is automated and includes:
a rotatable section including a terminal and a scanner;
a motor that automatically rotates the rotatable section in response to a mode signal; and
a station controller that generates the mode signal based on the remote mode instruction.
